(19) United States
(12) Patent Application Publication
(10) Pub. No.: US 2017/0246066 A1
(43) Pub. Date: Aug. 31, 2017

(54) PATIENT POSITIONING DEVICE

(71) Applicant: Revolutionary Medical Devices, Inc., Tucson, AZ (US)

(72) Inventors: Thomas M. Reilly, Tucson, AZ (US); Michael J. Pedro, Windham, NH (US); Steven H. Cataldo, New York, NY (US); Peter J. Krones, Katonah, NY (US); James E. Ellis, Tempe, AZ (US); David M. Kane, Tucson, AZ (US)

(21) Appl. No.: 15/510,469

(22) PCT Filed: Aug. 14, 2015
(86) PCT No.: PCT/US15/45357

§ 371 Date: Mar. 10, 2017

Related U.S. Application Data
(60) Provisional application No. 62/056,287, filed on Sep. 26, 2014.
(60) Provisional application No. 62/100,588, filed on Jan. 7, 2015.

(51) Int. Cl. A61G 13/12; A61G 13/00

(52) U.S. Cl. CPC A61G 13/121; A61G 13/0036; A61G 13/1285

(57) ABSTRACT

A device for use with an OR table for supporting a patient's head in a sniff position has a support assembly including a base and patient head support for mounting to an end of an OR table; a pneumatic or mechanical jack, or an expandable bellows, supporting the patient head support for raising or lowering the patient's head relative to the base; a rotatable axis allowing for flexion and extension of the neck; and a mounting assembly for mounting the support assembly to the end of the operating table.

The present invention relates to improvements in patient positioning devices, and a head support to facilitate the maintenance of a patent airway when a patient is either unconscious, unable to maintain a patent airway, or under sedation and/or anesthesia. In another aspect, the present invention relates to a positioning device to facilitate the maintenance of a patent airway while a patient is either unconscious, unable to maintain a patent airway, or under sedation and/or anesthesia.

Over the last decade the number of Monitored Anesthesia Care (MAC) cases have dramatically increased (several million being performed annually) and unfortunately so have the number of airway complications resulting in both death and brain damage. MAC cases use sedating medications in order to limit the amount of physical and psychological pain that the patient may experience. However, these sedating medications can cause relaxation of the muscles that help maintain an open airway. Relaxation of these muscles can then lead to the airway becoming obstructed (i.e., upper airway obstruction) and inhibiting the patient from breathing. Also, if a higher than expected dose of sedating medication is given it can lead to respiratory depression where the patient's brain fails to communicate when to take a breath.

Traditionally, in order to reduce the risk of an upper airway obstruction, a provider would first change the position of the patient's head by lifting the chin or by having the patient lie on his or her side. Lifting the head and chin places the patient in the “sniffing position” and allows the mandible to be displaced anteriorly. The sniffing position also aligns three axes (oropharyngeal, laryngeal, tracheal) and gives the provider the most optimal position for mask ventilation and view for intubation. Laying a patient on his or her side allows the tongue to extend forward and prevents gravity from causing the tongue to fall backward into the airway as it does when supine. However, these two positions only prevent upper airway obstruction in about half of these patients. If these maneuvers fail to relieve the upper airway obstruction, the provider may then perform a “jaw thrust”. This maneuver requires two hands, each hand holding behind the angle of the mandible and lifting the mandible forward/anteriorly, much further than the chin lift can. The obvious disadvantage of this maneuver is the use of two hands. This can become especially cumbersome when the patient is in the lateral position because the side of the jaw that the patient is lying on cannot be reached. Now the provider may struggle trying to accommodate all necessary tasks, such as giving emergency medications, keeping up to date charts, and monitoring vital signs.

Other problems are the difficulties in ventilation of obese patients. Obese patients not only have more soft tissue in their upper airways that leads to obstruction, they also have a tremendous amount of extra weight that compresses their chest, reducing air exchange. Laying an obese patient on his or her side, helps displace the weight off of his or her chest and when combined with a jaw thrust, can maximize ventilation.

The prior art has proposed various devices for facilitating maintenance of a patent airway enabling the sniff position and/or jaw thrust. See, for example, U.S. Pat. Publication No. 2012/0180220; U.S. Pat. No. 8,347,889; U.S. Pat. No 8,001,970; U.S. Pat. No. 8,191,553; U.S. Pat. No. 1,131,802; U.S. Pat. No. 1,441,817; U.S. Pat. No. 1,729,525; U.S. Pat. No. 1,776,167; U.S. Pat. No. 2,452,816; U.S. Pat. No. 4,700,691; U.S. Pat. No. 5,524,639; U.S. Pat. Publication No. 2012/0180220 and U.S. Pat. No. 7,467,431.

Also, in our PCT Application Serial No. PCT/US14/44934, we describe positioning devices for positioning and supporting patient while the patient is either unconscious, unable to maintain a patent airway or under sedation and/or anesthesia to facilitate the maintenance of a patent airway by correctly positioning a patient's back, shoulders, neck and head using an adjustable ramp with placement of the patient's back and shoulders to achieve a desired angle, and a head support for optimizing the sniffing position.

The present invention provides improvements to the support system described in the aforesaid prior art, including our aforesaid PCT Application.

While the patient positioning devices described in our aforesaid PCT Application Serial No. PCT/US14/44934 provide significant advantages over prior art devices, we have discovered that for most patients, the clinically recommended sniffing position can be obtained using a conventional OR table fitted with a head support assembly as will be described below. Additionally, the ramping function provided by the earlier device that increased the functional residual capacity (FRC) of a patient by inclining the patient, removing a portion of the body weight from the lungs, may be accomplished by raising or lowering the patient's back, shoulders and head, or by tilting the OR table in the reverse Trendelenburg position with the head support assembly of the present invention. Tilting the OR table in the reverse Trendelenburg position maximizes the functional residual capacity (FRC) of a patient's lungs by offloading body weight on the lungs and allows the patient to be placed in a sniffing position by using the head support assembly of the present invention, and provides adjustment to optimize the glottic view for intubation.

More particularly, in accordance with the present invention, in accordance with one aspect of our invention there is provided a device for retrofit use with an OR table for supporting a patient's head in a sniff position comprising a support assembly including a base and patient head support for mounting to an end of an OR table; a pneumatic or mechanical jack, or an expandable bellows, supporting the patient head support for raising or lowering the patient's head relative to the base; a rotatable axis allowing for flexion and extension of the neck; and a mounting assembly for mounting the support assembly to the end of the operating table.

In one aspect the mounting assembly comprises one or more clamps for attaching to an OR table.

In another aspect the mounting assembly comprises one or more rods for attaching to an OR table.

In yet another aspect the patient head support is slidably adjustable.

In still yet another aspect the mounting assembly includes an OR table interface plate.

In another and preferred aspect the mounting assembly is adjustable around a pivot point, preferably adjustable between 0° and 35°.

In yet another and preferred aspect, the patient head support includes a donut-shaped element, or a horse-shoe shaped element.

The present invention also provides a head support system for positioning a patient to facilitate maintenance of a patent airway comprising a head support pillow and a head support where the head support pillow comes into contact with the patient's head and/or neck on one side and the other side is in contact and can either be attached or detached from a pillow support on the OR table, wherein the pillow and pillow support allow for approximately 15° of head extension to place the patient in the desired “sniffing position”.

In one embodiment of the invention the pillow is donut or horse-shoe shaped having a generally flat top surface, while the pillow support is wedge shaped, so that the pillow on the pillow support provides for approximately 15% of head extension to place the patient in a desired sniffing position.

In another embodiment of the invention, the pillow is wedge shaped and the pillow support has a generally flat top surface, so that the pillow on the pillow support provides for approximately 15% of head extension to place the patient in a desired sniffing position.

In one embodiment, the head support system comprises a head lift mechanism for lifting the head support pillow/pillow system to provide patient neck flexion.

In yet another embodiment of the invention, the head support system comprises attachment points for mask anchor head straps for securing an anesthesia mask to the patient's face and the patient's head to the patient support surface.

In one embodiment, the head support pillow is detachable from the pillow support.

The present invention also provides a spacer mechanism for use with a patient positioning device which includes a ramp, which creates a level surface with respect to the positioning device to prevent uneven spaces on the patient support surface, and which allows a patient to be moved both lengthwise and widthwise. In such embodiment the spacer mechanism comprises a structure having two or more sides with a hollow inside, where the first side is rigid and securely attaches to another rigid support surface, such as an OR table or stretcher, and a second rigid side, which allows either a soft surface or a rigid surface, to rest on top of the second side and move either lengthwise in an x direction or widthwise in an y-direction to accommodate a patient's torso and move the patient into the desired position.

In a preferred embodiment the hollow is sized and shaped to accommodate an X-Ray cassette.

The present invention also provides a spacer mechanism for use with a patient positioning device which includes a ramp, which creates a level surface with respect to the positioning device to prevent uneven spaces on the patient support surface and allows a patient to be moved both lengthwise and widthwise. In such embodiment the mechanism comprises a structure having two sides where the first side is rigid and securely attaches to another support rigid surface such as an OR table or stretcher, and a second rigid side with a roller mechanism built inside, which allows either a soft surface or a rigid surface, to rest on top of to move the patient lengthwise along an x-axis or widthwise along an y-axis and to accommodate a patient's torso and move the patient into the desired position.

The present invention also provides an extension system for use with a patient positioning device which includes a ramp, for accommodating larger patients, comprising rigid side plates for attachment to the support ramp and/or back spacer, for increasing the width of the device to accommodate larger patients, and one or more soft elements for placement over the rigid base plates.

In one embodiment, the side spacer extensions have one or more hollows for accommodating and X-Ray cassette.

In yet another embodiment of the invention, the side spacer extensions include rollers to permit movement of the patient.

Further features and advantages of the present invention will be seen from the following detailed description, taken in conjunction with the accompanying drawings, wherein like numerals depict like parts, and wherein:

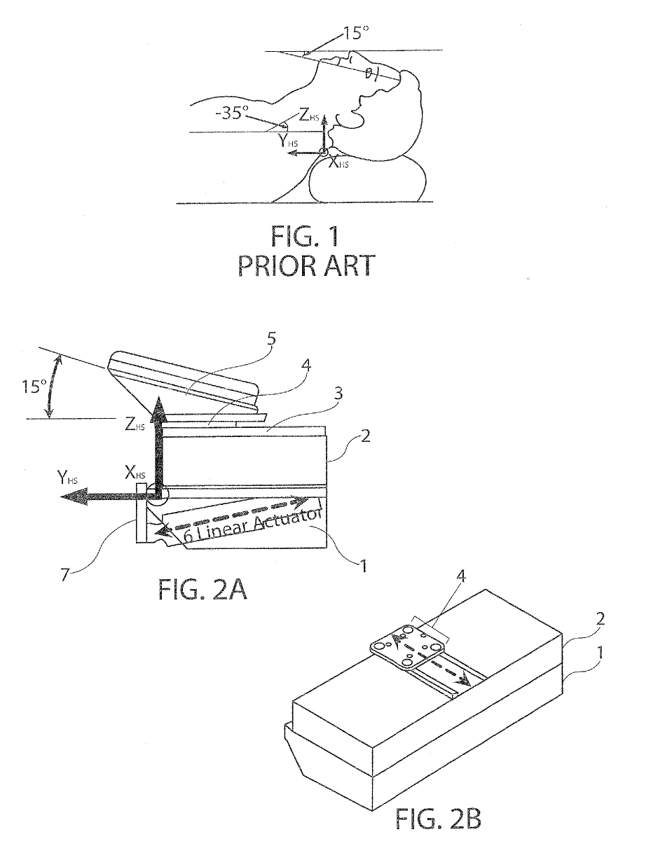

FIG. 1 graphically depicts the optimal “sniffing position”;

FIG. 2A is a side elevational view and FIG. 2B a perspective view, with the head wedge and donut removed for clarity of a head support assembly in accordance with the present invention;

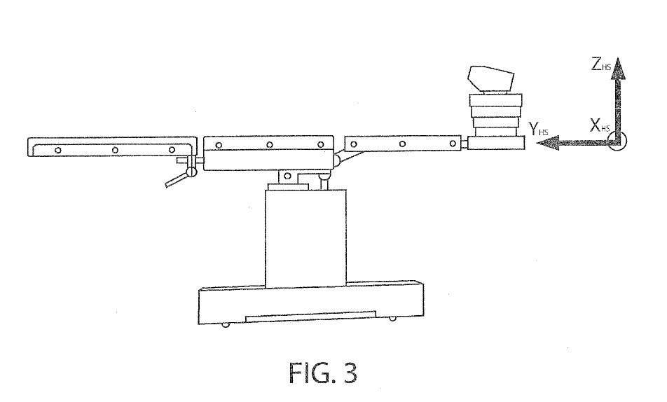

FIG. 3 is a side elevational view showing the head support assembly affixed to an OR table in accordance with the present invention;

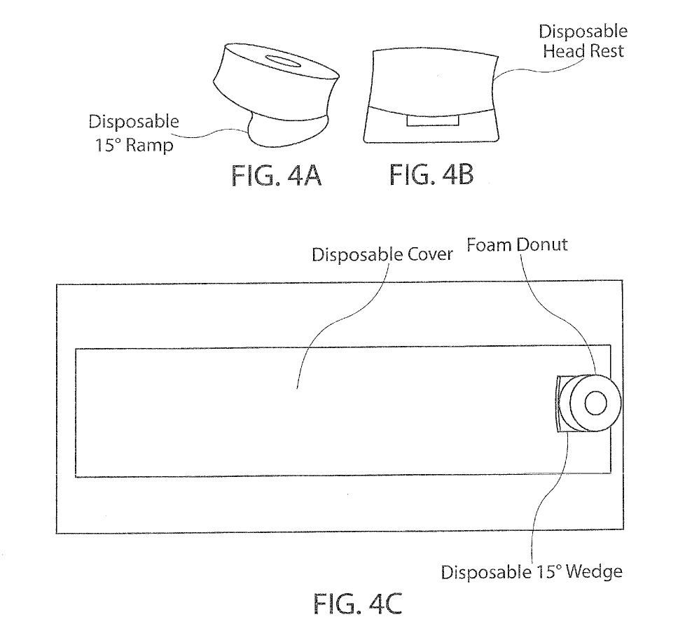

FIGS. 4A and 4B are side elevational views and rear views of a head rest and ramp (also called a wedge) in accordance with the present invention;

FIG. 4C is a top plan view of a cover and disposable head rest and wedge (also called a ramp) in accordance with the present invention;

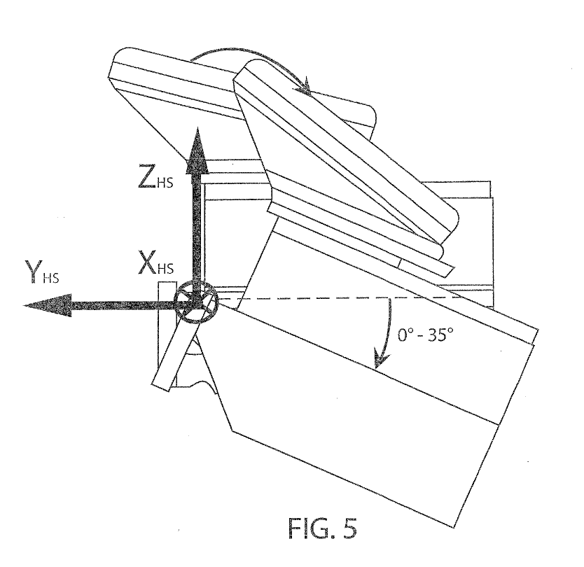

FIG. 5 is a side elevational view showing a head support assembly in two positions in accordance with the present invention, with the actual position being any point within the prescribed range as required;

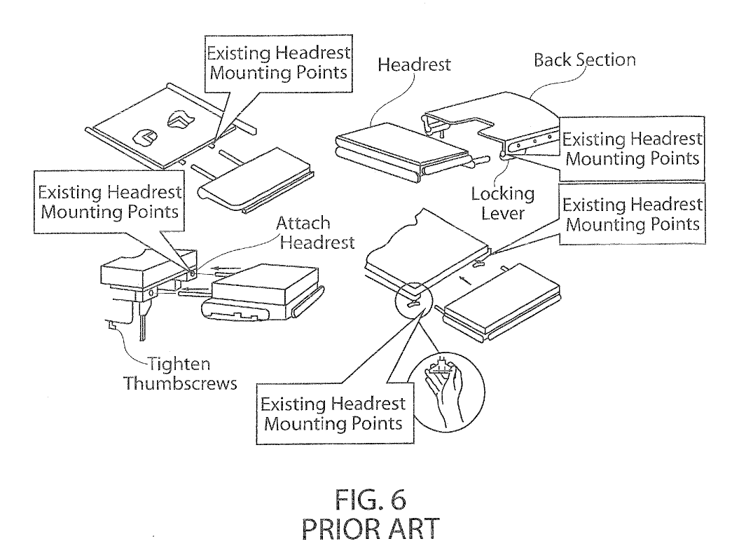

FIG. 6 are perspective views of examples of existing head rest mounting systems on conventional surgical tables;

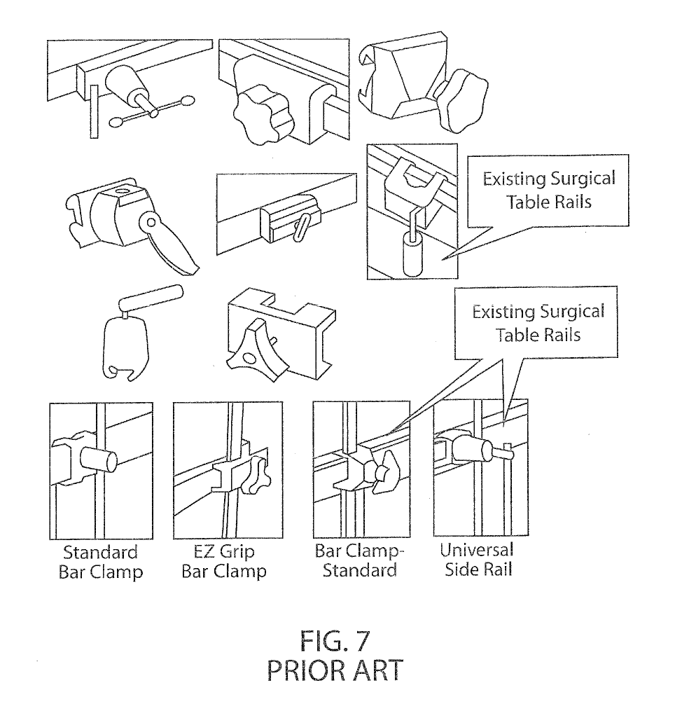

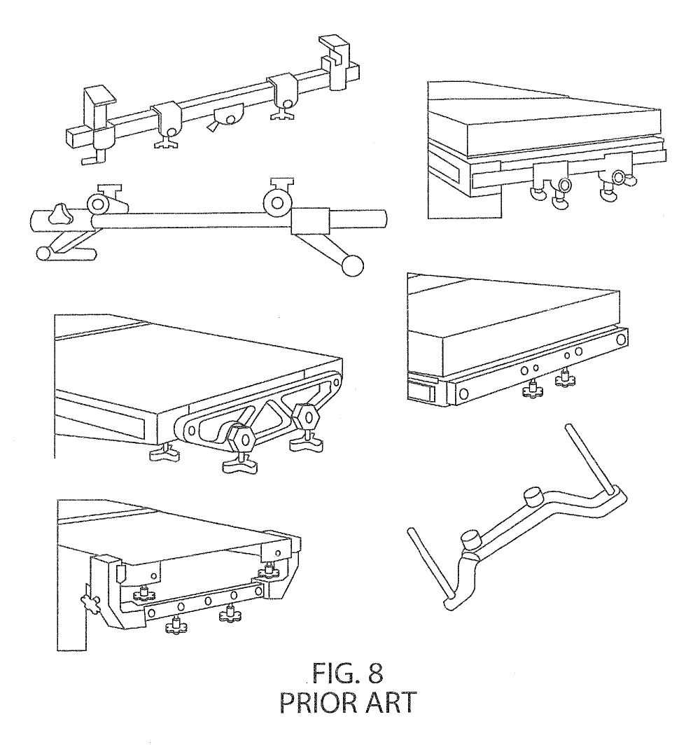

FIG. 7 is a series of conventional surgical rail and surgical rail clamps;

FIG. 8 are examples of surgical table head rest adapters;

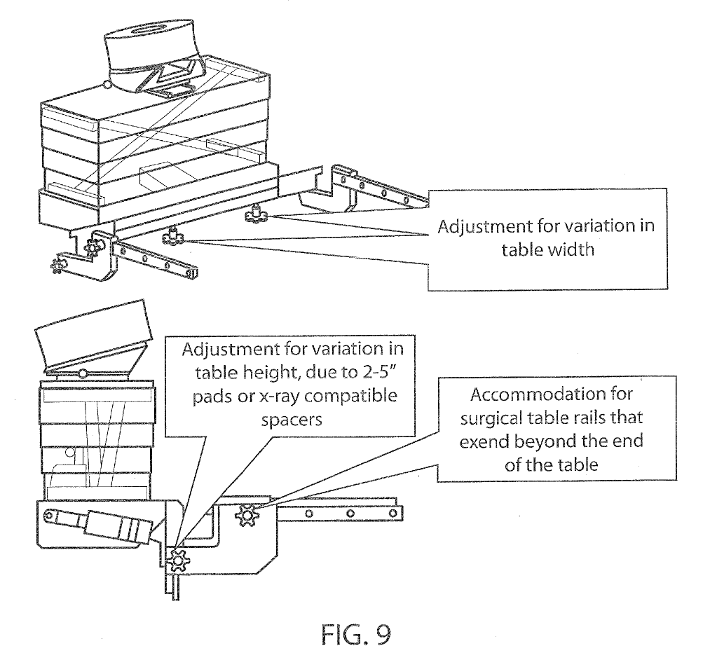

FIG. 9 are perspective views of a head rest assembly and mounting system in accordance with the present invention;

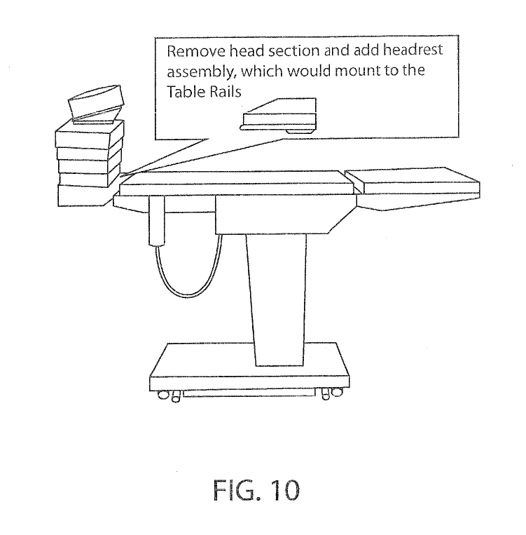

FIG. 10 is a perspective view of an operating table with a head rest assembly in accordance with the present invention;

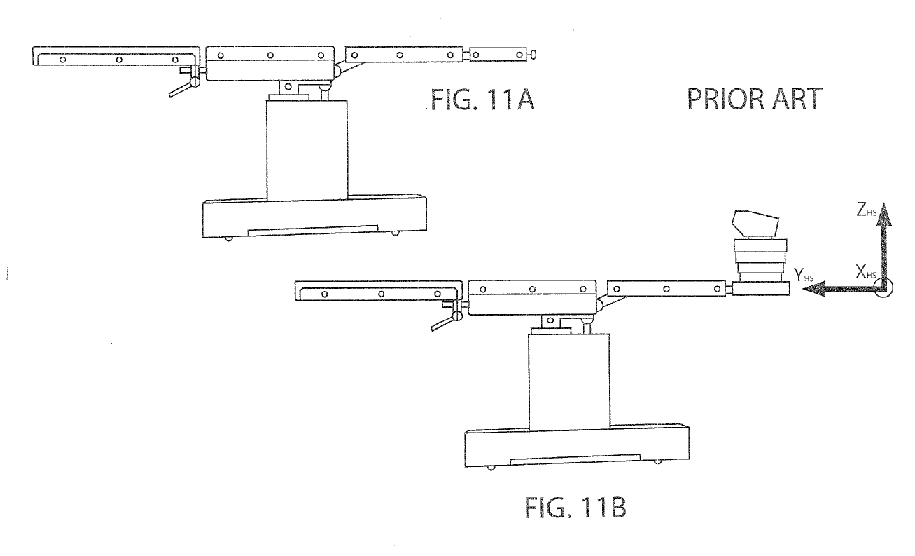

FIG. 11A is a side elevational view of a conventional OR table, and FIG. 11B is a view similar to FIG. 11A showing a head rest fitted to the OR table in accordance with the present invention;

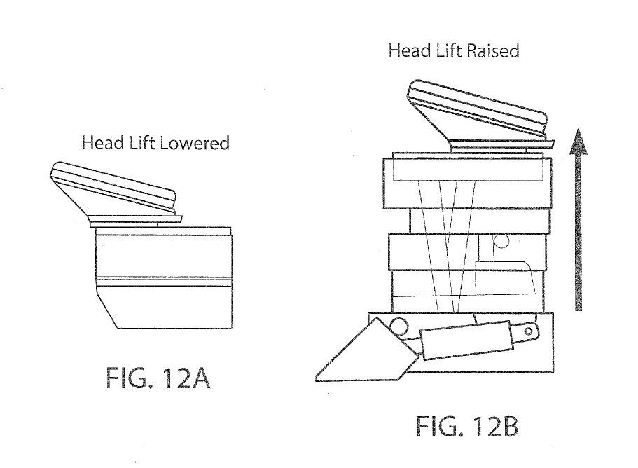

FIG. 12A shows a head rest in accordance with the present invention in a lowered position and FIG. 12B shows the same head rest in a raised position;

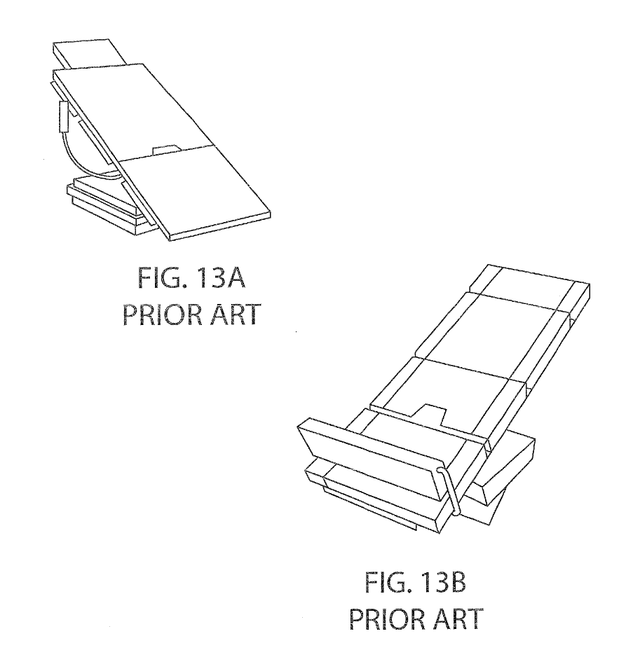

FIGS. 13A-13B show a conventional OR table and illustrate how the table may be tilted to place a patient in a reverse Trendelenburg position;

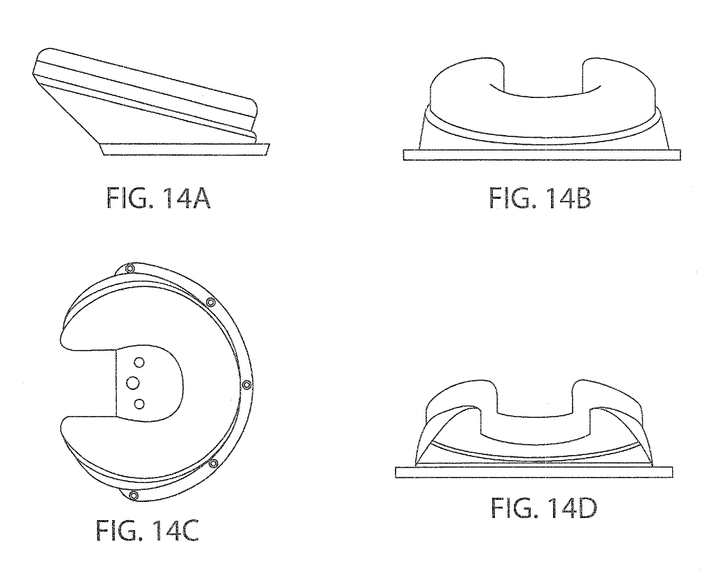

FIGS. 14A-14D illustrate a horse-shoe donut and wedge head support in accordance with one embodiment of the present invention;

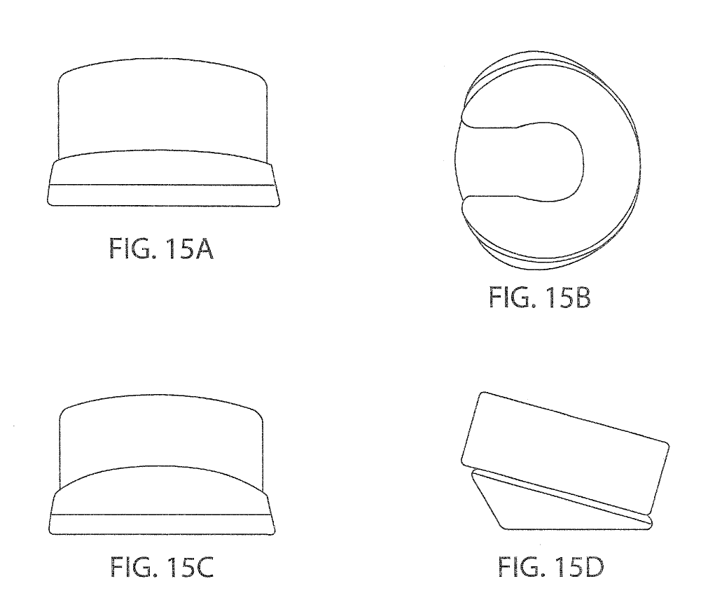

FIGS. 15A-15D illustrate a full round donut and wedge head support in accordance with another embodiment of the present invention;

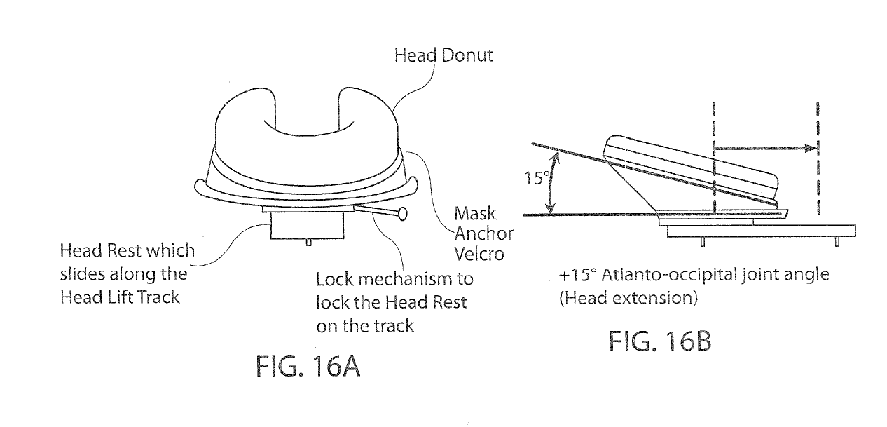

FIGS. 16A-16B show details of the head rest glide in accordance with the present invention;

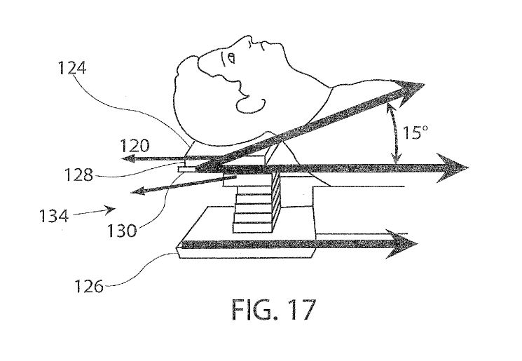

FIG. 17 is a side elevational view; creating the head support system in accordance with the present invention;

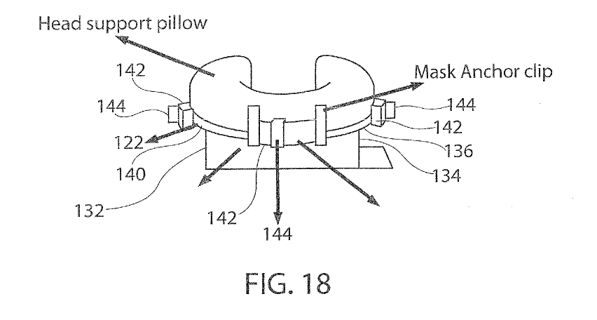

FIG. 18 is a perspective view of details of a head support pillow, head support wedge in accordance with the present invention;

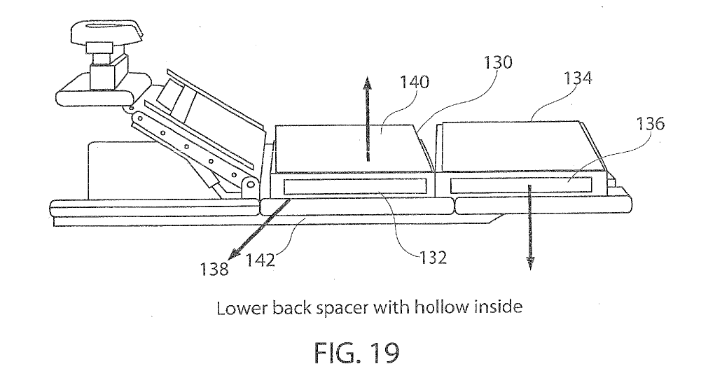

FIG. 19 is a side perspective view of a patient ramp and support system with back and leg spacers in accordance with the present invention;

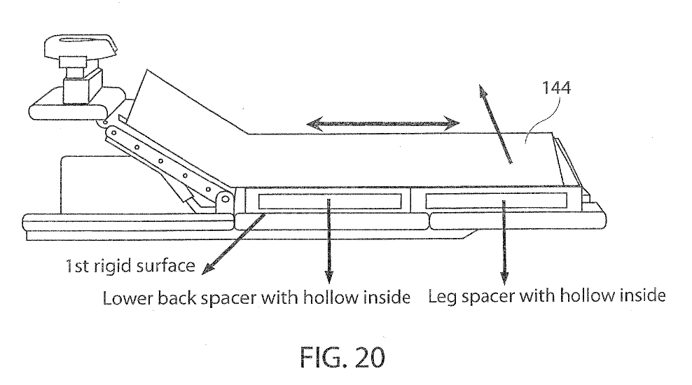

FIG. 20 is a view similar to FIG. 19, and showing a pad overlaying the back and leg spacers;

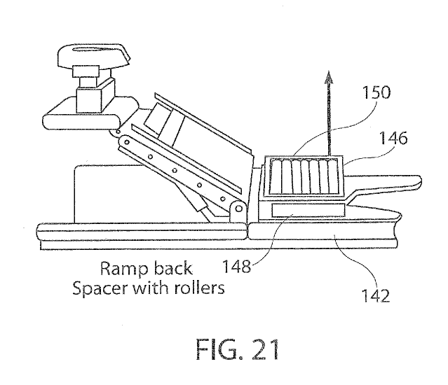

FIG. 21 is a view, similar to FIG. 20, and showing a ramp spacer with rollers;

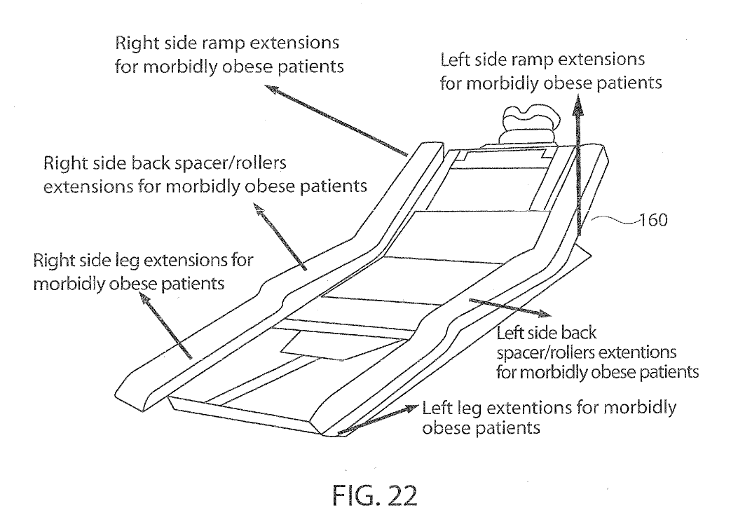

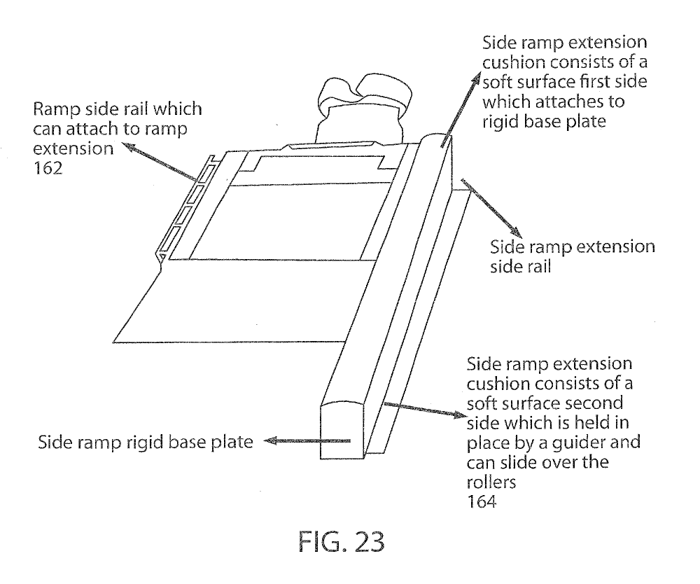

FIGS. 22 and 23 are perspective views showing another embodiment of the invention;

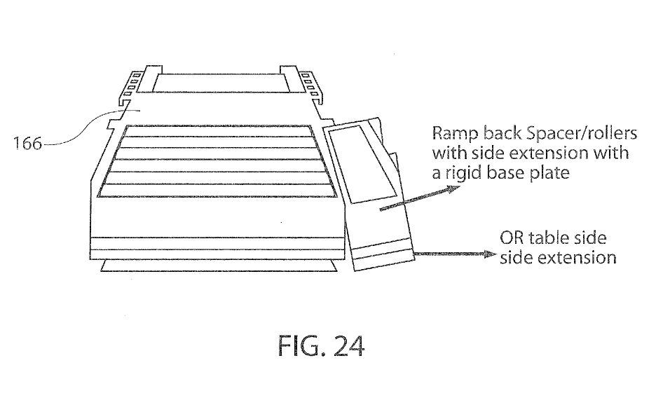

FIG. 24 is a perspective view showing a ramp/back spacer with rollers; and

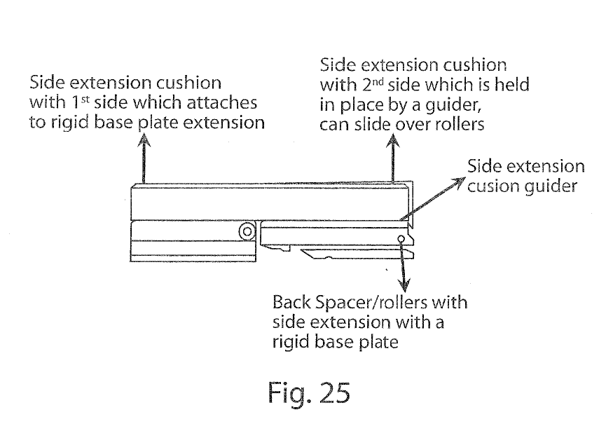

FIG. 25 is a side elevational view thereof.

Major elements of the head support assembly in accordance with one embodiment of the present invention as well as its coordinate system reference are shown in FIG. 2, and their associated functions are provided in Table 1.

TABLE 1
Major Elements of The Head Support Assembly

| # | Element | Function |
|---|---|---|
| 1 | Head Support | Transmits head load to the OR Table. Also provides rotation |
| | | of the head about the X_{HS} axis when the Linear Actuator (6) |
| | | is expanded or contracted in order to optimize the intubation |
| | | view |
| 2 | Head Lift | Moves the head along the Z_{HS} axis in order to optimize the |
| | | intubation view. |
| 3 | Slide Rail | Allows for translation of the Head Slide (4) along the Y_{HS} |
| | | axis |
| 4 | Head Slide | Accommodates variation in the change in geometry, given |
| | | the patients neck length is fixed, when the angle of the head |
| | | support about the X_{HS} axis or the Head Lift height along the |
| | | Z_{HS} axis vary. This accommodation occurs by sliding along |
| | | the Slide Rail (3) that is alighted with the Y_{HS} axis. See FIGS. |
| | | 16A-16B. |
| 5 | Head Wedge and | This portion of the Head Support Assembly interfaces |
| | Donut | directly with the head of the patient and the Head Slide, |
| | | placing the patients head in the nominal 15° sniffing |
| | | position. Note the Head wedge and donut can be either |
| | | reusable, or part of a Disposable product. |
| 6 | Linear Actuator | The expansion or contraction of the linear actuator that is |
| | | connected to the OR Table Interface Plate (7) and the Head |
| | | Support (1) will result in a corresponding rotation about the |
| | | X_{HS} axis where there is a pivot point between the OR Table |
| | | Interface Plate (7) and the Head Support (1) |
| 7 | OR Table | The OR Table Interface Plate connects the Head Support |
| | Interface Plate | Assembly to the OR Table. All loads for the head are |
| | | transmitted through the assembly to this plate and on to the |
| | | OR Table |

The headrest supports a patient's head angle of about 15° between the facial plane and the horizontal.
The Head Lift can increase (raise) or decrease (lower) coordinate Z_{HS}, which raises or lowers the patient's head and neck respectively, from 0″ to 6″ about the Z_{HS} axis.
The Head Support can increase or decrease the angle of the patient's atlantooccipital joint from +5° to 0° to −35° , about the X_{HS} axis of the device as shown in FIG. 5.
At the top of the head lift is the headrest, which consists of a donut pad to provide comfort and proper head positioning during anesthesia and surgery, the track which allows the headrest to translate along the Y_{HS} axis to accommodate rotation and translation of the head support and head lift, and the headrest lock, shown in FIG. 5.
The track is designed to account for the difference between the patient's linkage (pivot points) and the linkage pivot points.
A reusable headrest (top portion of the head lift and donut pad) FIGS. 14A-14D is removable, to allow it to be repositioned with the patient when surgeries require a patient to be repositioned on the OR table for optimal access and can be covered by a disposable Head wedge/donut & cover, FIG. 4C.
A headrest and donut can also be integrated into the disposable cover and be a disposable accessory, 4C. See also FIGS. 4A-4B; 15A-15D for other examples of headrests and donuts in accordance with the present invention.
The donut is placed at 15° to provide patient head extension for proper patient positioning.

The head support assembly can be mounted at either end of the surgical table, in a manner similar to an existing surgical table headrest. In order to support attaching to the variety of surgical tables available the mounting should adjust for the following:
Variation in the length the surgical table rails extend or are retracted beyond the table.
Variation in the length the headrest mounting points extend or are retracted beyond the table.
Variation in the size of the table rails (US, EU, UK, Japan, or Denyer) or variation in the size of the headrest mounting points.
Variation in the width of the OR table including Bariatric tables.
Variation in the height of the OR table with 2-5″ pads and x-ray compatible table surfaces spacers.

The head support device can mount to the surgical table in several ways: (1) Integrated into an OR table replacing the head rest as either a removable or non-removable section (1) Utilize the existing surgical table headrest mounting; examples are show FIG. 6; (2) Utilizing the existing surgical table accessory side rails and available or custom clamps; examples are show in FIG. 7; or (3) Utilize an available or custom surgical table headrest adaptor, examples are show in FIG. 8.

Examples of mounting systems are shown in FIGS. 6-9, with adjustments for table width, height, and rail length.

Various changes may be made in the foregoing invention without departing from the spirit and scope thereof. For example, rather than employing a mechanical jack for lifting the patient's head, a pneumatic or an expandable bellows head rest lift device may be provided in accordance with our aforesaid PCT Application Serial No. PCT/US14/44934, the contents of which are incorporated herein by reference.

Also, if desired, the head rest assembly may include brackets or hook and loop fixing points for holding a mask and the patient's head to the head support such as described in, for example, in our aforesaid PCT Application Serial No. PCT/US14/44934, the contents of which are incorporated herein by reference.

The present invention provides significant advantages over conventional patient positioning devices, and also provides advantages over the patient positioning device described in our aforesaid PCT Application Serial No. PCT/US14/44934. For one, the device is significantly simpler, and adds little weight to the OR table, thus less minimally reducing the maximum load of the table. Additionally, since the patient is simply being tilted without bending, i.e., by tilting the OR table (see FIGS. 13A-13B), there is no need to adjust the patient's position on the table for the patient's height. Additionally, the device may be mounted to either end of an OR table and if desired left on the table, or easily moved from OR table to another.

A head support system in accordance with an another embodiment of the invention is shown in FIG. 17, and comprises a head support pillow 120 with two sides, a head support wedge 122 with five sides, where a first (upper) side 124 of the head support pillow comes into contact with the patient's head and/or neck is, when employed with an operating room table or head support base plate 126, is angled at approximately 15° to allow for approximately 15° of head extension and place the patient in the desired “sniffing position”. The second (lower) side 128 of the head support pillow can be either attached to the head support wedge 122 or designed to be detached from the head support wedge 122 and placed anywhere on the patient support surface, such as but not limited to an OR table or stretcher, and placed under a patient's head without having a 15° wedge. Side 130 of the head support wedge 122 is what allows side 128 of the head support pillow to attach or detach to it. Side 132 of the head support wedge, which comes into contact with the head lift, can be either attached to the head lift 134 or able to be detached from the head lift 134 and placed anywhere on the patient support surface, such as but not limited to an OR table and placed under a patient's head and able to maintain the optimal 15° head extension. The 3rd, 4^{th}, and 5^{th} side edges 136, 138, 140 of the head support wedge 122 have rails 142 attached to it and have attachment mechanisms 144 which are attached to the rails (FIG. 18). The function of sides 136, 138, 140 are to allow a head strap to attach to it and secure the patient's head and neck in place, even when the angles of the patient's head and/or neck are changed (FIG. 18).

A centered attachment mechanism, such as but not limited to, a mask anchor clip 144 (FIG. 18) and described in more detail in our co-pending PCT Application Serial No. PCT/US15/34277, filed Jun. 4, 2015, secures an anesthesia head strap to an anesthesia mask, which in turn then secures the patient's head to the patient support surface, maintains the patient's head in position, and prevents the patient's head from falling off of the head rest when adjusting the height and angle of the head and/or neck.

The Ramp Device with a Spacer with No Rollers

In another aspect, the present invention provides improvements in devices for positioning a patient on an inclined surface as described in our aforesaid PCT Application Serial No. PCT/US14/44934. More particularly, in accordance with the present invention, it is provided a positioning device comprising a lower back spacer 130 with a hollow 132 inside and the leg spacer 134 with a hollow 136 inside (FIG. 19) which comprises of two rigid sides 138, 140, where the first rigid side 138 attaches to another rigid surface such as but not limited to an OR table 142 or stretcher to secure it to that surface and prevent it from moving, and a second rigid surface or side 140 and allow either a soft surface or a rigid surface such as but not limited to a cushion 144, pad, Teflon sheet, etc to rest on top of and move either lengthwise in the x direction or width wise in the y-direction to accommodate the size of any patient's torso (FIG. 20). Another function of the leg and back spacers with hollow insides is to ensure that when a patient lies on the surfaces, the surface is level with the ramp device to prevent any uneven step-offs, which may result in complications (FIG. 20). The hollows 132, 136 also are designed to accommodate an x-ray cassette and enable the provider to take x-rays of the lower part of the body without having to remove the leg and back spacers from the patient support surface (FIG. 20).

The Ramp Device with a Spacer with Rollers

In another embodiment the lower back spacer with rollers and a leg spacer with rollers 140 (FIG. 21), which consists of two rigid sides, where the first rigid side 148 attaches to another rigid surface such as but not limited to an OR table 142 or stretcher to secure it to that surface and prevent it from moving, and a second rigid surface 150 with a mechanism built inside, such as but not limited to a roller mechanism, which allows either a soft surface or a rigid surface, such as but not limited to, a cushion, pad, Teflon sheet (not shown), etc to rest on top of to move lengthwise along the x-axis or width wise along the y-axis and to accommodate the size of any patient's torso (FIG. 21). Another function of the leg rollers 146 is to be custom fit to a patient support surface, such as but not limited to, an OR table, in such a way, that the rollers do not interfere with either surgical positioning or the function of the patient surface (FIG. 21).

Ramp device with Side Extensions

Yet another embodiment of the invention is illustrated in FIGS. 22-25. Here the device includes side extensions (FIG. 22) comprising of side extension rigid base plates 160 with three or more sides and side extension soft surfaces with one or more sides, where the first side extension rigid base plate side attaches to the ramp's side rail 162 in order to increase the width of the device for larger patients (FIG. 23). The second side extension rigid base plate side also has a side rail attached to it. The third side extension rigid base plate side has an attachment, which attaches to one side of the side extension soft surface 164. The first side of the soft surfaces lies on top of the third side of the rigid base plate surfaces and has two ends, where the first end attaches to the rigid base plate, to prevent the soft surfaces from moving off of the rigid surfaces and the second end lies on top of the ramp back spacer/roller extension and is not secured to the ramp back spacer/roller extension 166 in order to allow the soft surface to slide over the ramp back spacer/roller extension when the ramp is extended (FIG. 24).

The back spacer/roller side extensions (FIGS. 24, 25) comprise of a rigid base plate where one side attaches to the OR table's side extension in order to increase the width of the device for larger patients, and a soft cushion, which lies on top of the rigid surface. The soft cushion is continuous with the side ramp extension cushion and at the second end it is held in place by a guider, in order to allow it to slide over the rollers when the ramp extends and contracts (FIGS. 24, 25).

Various changes may be made in the above invention without departing from the spirit and scope thereof. For example, as described in connection with the first embodiment of the invention, the support pillow may be donut shaped or horse-shoe shaped having a generally flat support surface. Alternatively, the head support pillow should have a generally flat top surface for engagement with a base which has approximately 15% angle to allow for 15% of head extension thereby to place the patient in a desired sniffing position. Alternatively, the support pillow may be wedge-shaped to allow for 15% of head extension to place the patient in a desired sniffing position.

Yet other features and advantages will be apparent to one skilled in the art.

1. An adjustable device for use with an OR table for supporting a patient's head in a sniff position comprising a support assembly including a base and patient head support for mounting to an end of an OR table; a pneumatic or mechanical jack, or an expandable bellows, supporting the patient head support for raising or lowering the patient's head relative to the base; a rotatable axis allowing for flexion and extension of the neck; and a mounting assembly for mounting the support assembly to the end of the operating table.

2. The device of claim 1, wherein the mounting assembly comprises one or more clamps or rods for attaching to an OR table.

3. The device of claim 1, wherein the patient head support is slidably adjustable.

4. The device of claim 1, wherein the mounting assembly includes an OR table interface plate.

5. The device of claim 1, wherein the mounting assembly is adjustable around a pivot point, preferably between +5° to 0° to −35°.

6. The device of claim 1, wherein the patient head support includes a donut-shaped or a horse-shoe shaped element.

7. The device of claim 1, installed on an OR table. wherein the OR table is adjusted to the reverse Trendelenburg position, so as to maximize the functional residual capacity of the patient's lungs by offloading body weight on the lungs and allowing the patient to be placed in a sniffing position and adjusting the device to optimize the glottis view for intubation.

8. A head support system for positioning a patient to facilitate maintenance of a patent airway comprising a head support pillow and a head support where the head support pillow comes into contact with the patient's head and/or neck on one side and the other side is in contact and can either be attached or detached from a pillow support on the OR table, wherein the pillow and pillow support allow for approximately 15° of head extension to place the patient in the desired “sniffing position”.

9. The head support system of claim 8, wherein the pillow is donut or horse-shoe shaped having a generally flat top surface, while the pillow support is wedge shaped so that the pillow on the pillow support provides for approximately 15% of head extension to place the patient in a desired sniffing position, or the pillow is wedge shaped and the pillow support has a generally flat top surface, so that the pillow on the pillow support provides for approximately 15° of head extension to place the patient in a desired sniffing position.

10. The head support system of claim 8, further comprising one or more of the following features
(a) a head lift mechanism for lifting the head support pillow/pillow system to provide patient neck flexion;
(b) attachment points for mask anchor head straps for securing an anesthesia mask to the patient's face and the patient's head to the patient support surface; and
(c) wherein the head support pillow is detachable from the pillow support.

11. A spacer mechanism for use with a patient positioning device which includes a ramp, which creates a level surface with respect to the positioning device to prevent any uneven spaces on the patient support surface and which allows a patient to be moved both lengthwise and widthwise, wherein the mechanism comprises a structure having two or more sides optionally with a hollow inside, where the first side is rigid and securely attaches to another rigid support surface, and a second rigid side, which allows either a soft surface or a rigid surface, to rest on top of the second side and move either lengthwise in an x direction or widthwise in an y-direction to accommodate a patient's torso and move the patient into the desired position, and further wherein the optional hollow preferably is sized and shaped to accommodate an X-Ray cassette.

12. The spacer mechanism of claim 11, wherein the mechanism alternatively comprises a structure having two sides where the first side is rigid and securely attaches to another support rigid surface, and a second rigid side with a roller mechanism built inside, which allows either a soft surface or a rigid surface, to rest on top of to move the patient lengthwise along an x-axis or widthwise along an y-axis and to accommodate a patient's torso and move the patient into the desired position.

13. An extension system for use with a patient positioning device which includes a ramp and/or back, for accommodating larger patients, comprising rigid side plates for attachment to the support ramp and/or back to increase the width of the device to accommodate larger patients, and one or more soft elements for placement over the rigid base plates.

14. The accessory of claim 13, wherein the side spacer extensions have a hollow for accommodating and X-Ray cassette.

15. The accessory of claim 13, wherein the side spacer extensions include rollers to permit movement of the patient.
